(19) United States
(12) Patent Application Publication
(10) Pub. No.: US 2004/0258083 A1
(43) Pub. Date: Dec. 23, 2004

(54) [METHOD FOR ESTIMATING CHANNEL LENGTH DYNAMICALLY]

(76) Inventor: Chih-Hao Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/250,291

(22) Filed: Jun. 20, 2003

(51) Int. Cl. H04J 3/16

(52) U.S. Cl. 370/437; 370/310

(57) ABSTRACT

A method for estimating the channel length of a wireless communication system dynamically is provided. The method estimates the best channel length in a preset range of channel length during a preset period. The best channel length is used to recover data received by an equalizer. Therefore, the calculation accuracy for data recovery is increased, while the calculation complexity for data recovery is not increased too much.

### BACKGROUND OF INVENTION

1. Field of Invention

The present invention generally relates to a wireless communication system, and more particularly, to a method for estimating the channel length dynamically for a wireless communication system.

2. Description of Related Art

Accompanying society's progress, communication between people is getting more and more frequent, and thus various communication tools assisting people's communication have become gradually well developed. Recently, thanks to electronic technology, many kinds of the wireless communication systems like the GSM mobile phone communication system, CDMA mobile phone communication system, and 3G mobile phone communication system have become indispensable mobile phone communication tools.

In all kinds of the wireless communication systems, the data is transmitted in air. Thus, the received signal is not as pure as in wire transmission when data is transmitted from a sending side to a receiving side, and instead it is a combination of data arrived at different time points through different transmission paths. In addition, the possible transmission path also varies depending on the sort of environment. Therefore, a data recovery circuit in an equalizer is required to separate and recover the received data.

Generally, in the data recovery circuit of the equalizer, in order to simplify the calculation process of data separation and recovery, it is common that the method for estimating the channel length uses a fixed channel whose memory length is 3 symbols to estimate its channel characteristics. Since the physical channel length varies depending on the sort of environment, when the physical channel length is longer, its performance is poorer when compared with the method for estimating the channel length by using a shorter channel length. Also, if the channel length is set as a longer value, the calculation complexity is also increased.

### SUMMARY OF INVENTION

To solve the problem mentioned above, the present invention provides a method for estimating the channel length dynamically. The method can change the channel length setup based on different transmission environments, so as to increase the calculation accuracy of the data recovery. In addition, when the channel length of the physical environment is longer, a maximum likelihood sequence estimation of the equalizer is used for calculation, so as to decrease the operation complexity.

In order to achieve the object mentioned above and others, the present invention provides a method for estimating the channel length dynamically. The method is suitable for using in a wireless communication system such as a GSM mobile phone communication system. The method for estimating the channel length dynamically comprises the steps of: estimating a best channel length in a preset range of the channel length during a preset period; and outputting the best channel length mentioned above.

In a preferred embodiment of the present invention, the step for estimating the best channel length of the method for estimating the channel length dynamically comprises the steps of: setting the preset period mentioned above; setting the preset range of the channel length mentioned above; estimating a channel error value for each channel length in the preset range of the channel length; selecting a channel length having a minimum channel error value according to the channel error value for each channel length in the preset range of the channel length, and summating an accumulative total of the channel length; and when the preset period is expired, selecting the channel length having the maximum accumulative total as the best channel length.

In an embodiment, the preset period that has been set up is less than 15 time slots.

In an embodiment, the preset range of the channel length that has been set up is from 3 to 7 channel lengths.

In an embodiment, the best channel length is output to an equalizer of the wireless communication system and used by it. The equalizer uses the best channel length for a maximum likelihood sequence estimation to recover the received data.

From descriptions mentioned above, the method for estimating the channel length dynamically provided by the present invention is able to change the setting of the channel length adapted to different transmission environments, so as to increase the calculation accuracy of the data recovery. When the channel length of the physical environment is longer, the maximum likelihood sequence estimation of the equalizer is used for its calculation, so as to reduce the calculation complexity.

### BRIEF DESCRIPTION OF DRAWINGS

The accompanying drawings are included to provide a further understanding of the invention, and are incorporated in and constitute a part of this specification. The drawings illustrate embodiments of the invention, and together With the description, serve to explain the principles of the invention.

FIG. 1 schematically shows a diagram for the data transmitted through the wireless communication system.

FIG. 2 schematically shows a diagram for the transmission data of the wireless communication system according to FIG. 1.

FIG. 3 schematically shows a flow chart of a method for estimating the channel length dynamically of the preferred embodiment according to the present invention.

### DETAILED DESCRIPTION

Referring to FIG. 1, it schematically shows a diagram for the transmission of the wireless communication system. As shown in FIG. 1, after the signal is sent out from a sending side 110, it may encounter different kinds of barriers such as building 130 or mountain 140 during the transmission period, thus the receiving side 120 receives the transmitted signal from different transmission paths 111, 112 and 113. Accordingly, the signal received by the receiving side 120 is a combination of the data that arrives in different time points and via different paths. In addition, the possible transmission path may be varied depending on the sort of environment. Accordingly, the data recovery circuit such as an equalizer is required to separate and recover the data physically received.

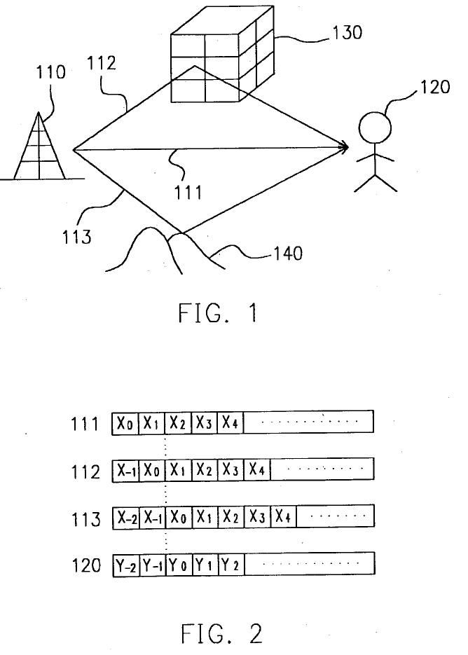

FIG. 2 schematically shows a diagram for the data transmitted through the wireless communication system according to FIG. 1. The row marked as 120 represents data that is physically received by the receiving side 120 of FIG. 1. The row marked as 111 shows data that is transmitted and received by the receiving side 120 via the path 111 of FIG. 1. The row marked as 112 shows data that is transmitted and received by the receiving side 120 via the path 112 of FIG. 1. The row marked as 113 shows data that is transmitted and received by the receiving side 120 via the path 113 of FIG. 1. Wherein, X0, X1, X2, X3, X4, â [symbol] represents a known training sequence data for each frame.

Here, it is assumed that the best channel length obtained by using the method for estimating the channel length dynamically according to the present invention is 3, and in order to separate and recover the data carried by the frame, a known training sequence data should be applied to obtain a ratio of the transmission signal when it is transmitted via different paths 111, 112, and 113. It is assumed that the ratio of the transmission signal via different paths 111, 112, and 113 is S0, S1, and S2, respectively. The physically received data Y0, Y1, and Y2 that does not contain the unknown data are used to calculate S0, S1, and S2, and their equations are as follows.

Y0=S0*X2+S1*X1+S2*X0 (1)

Y1=S0*X3+S1*X2+S2*X1 (2)

Y2=S0*X4+S1*X3+S2*X2 (3)

In the simultaneous equations of equation (1)˜(3), Y0, Y1, Y2, and X0, X1, X2, X3, and X4 are all known variables, thus the unknown variables S0, S1, and S2 can be obtained. In addition, the obtained S0, S1, and S2 can be used to separate and recover the unknown data carried by the frame.

Since the transmission path varies depending on the sort of environment, the best channel length, e.g. 3 in the example above, also varies when the environment is changed. If the equalizer uses a constant channel length for its calculation, when the physical channel length is longer, its performance is poorer when compared with the method for estimating the channel length by using a shorter channel length. However, if the channel length is set as a fixed value that is longer, according to the method for solving the simultaneous equations mentioned above, the calculation complexity will be significantly increased. Therefore, the method for estimating the channel length dynamically according to the present invention can be used to estimate the best channel length for the equalizer, and both the calculation accuracy and the calculation complexity are appropriately considered.

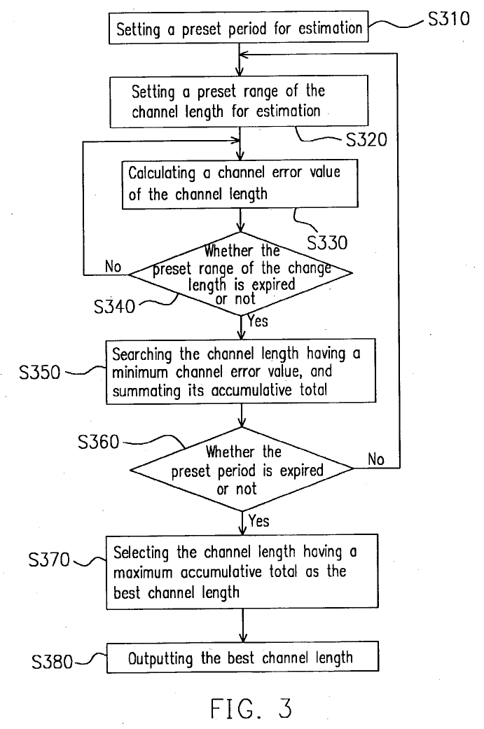

FIG. 3 schematically shows a flow chart of a method for estimating the channel length dynamically of the preferred embodiment according to the present invention. The method for estimating the channel length dynamically uses a GSM mobile phone communication system as an example for description. As shown in the drawing, the method for estimating the channel length dynamically sets a preset period that is to be estimated (S310). For example, the preset period can be set as 10 time slots, wherein the number 10 is smaller than 15. When the method for estimating the channel length dynamically is applied, each 10 time slots will generate a best channel length value that is to be used by the equalizer in the GSM mobile phone communication system, so as to separate and recover the received data. Such a method is advantageous in adapting to the variance of the user environment and periodically updating the best channel length, as well as the increase of the calculation accuracy for data recovery.

After setting of the preset period in step S310, the process enters into step S320, in which the preset range of the channel length to be estimated is set. The bigger the preset range of the channel length, the better its capability for adapting to the variance of different transmission environments. However, the time needed for the estimation is also increased. Here, the preset range of the channel length is set as 3 to 7 channel lengths based on the simulation result. Then, the process enters into step S330, in which a channel error value of the channel length is calculated, then entering into step S340 to determine whether the calculation of the channel error values for all the channel lengths in the preset range of the channel length is completed or not. If not, returning back to S330 step to calculate the channel error value for next channel length. Otherwise, the process enters into step S350.

In step S350, the channel length having a minimum channel error value is searched according to the channel error value obtained from the calculation in the step mentioned above, and an accumulative total of the channel length is summated, wherein the accumulative total represents the number of channel lengths having the minimum channel error value in the calculation of the channel error value. Then, the process enters into step S360 to determine whether the preset period is expired. If the preset period is not expired yet, the process returns back to step S320. If the preset period is expired, the process enters into step S370 to select the channel length having the maximum accumulative total as the best channel length, and the process enters into step S380 in which the best channel length is output. The best channel length is used by the equalizer in the GSM mobile phone communication system to separate and recover the received data. In order to reduce the calculation complexity in the case where the best channel length is longer, the equalizer may use the maximum likelihood sequence estimation.

In summary, the present invention at least has following advantages: 1. The method for estimating the channel length dynamically provided by the present invention is able to change its setting for the channel length for adapting to different transmission environments, so as to increase the calculation accuracy for data recovery. 2. When the channel length is longer in the physical environment, the maximum likelihood sequence estimation of the equalizer can be used to reduce the calculation complexity.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A method for estimating a channel length dynamically, suitable for a wireless communication system, comprising the steps of:
estimating a best channel length in a preset range of the channel length within a preset period; and
outputting the best channel length.

2. The method for estimating the channel length dynamically of claim 1, wherein the step of estimating the best channel length comprises the steps of:
setting the preset period;
setting the preset range of the channel length;
estimating a channel error value for each channel length in the preset range of the channel length;
selecting a channel length having a minimum channel error value according to the channel error value for each channel length in the preset range of the channel length, and
summating an accumulative total of the channel length; and
when the preset period is expired, selecting the channel length having a maximum accumulative total as the best channel length.

3. The method for estimating the channel length dynamically of claim 1, wherein the preset period is less than 15 time slots.

4. The method for estimating the channel length dynamically of claim 1, wherein the preset range of the channel length is 3 to 7 channel lengths.

5. The method for estimating the channel length dynamically of claim 1, wherein the best channel length is output to an equalizer of the wireless communication system and used by the equalizer.

6. The method for estimating the channel length dynamically of claim 5, wherein the equalizer uses the best channel length with the maximum likelihood sequence estimation.

7. The method for estimating the channel length dynamically of claim 1, wherein the wireless communication system is a GSM mobile phone communication system.
